(19) United States
(12) Patent Application Publication
(10) Pub. No.: US 2013/0269184 A1
(43) Pub. Date: Oct. 17, 2013

(54) PICK AND PLACE NOZZLE

(71) Applicants: Richard A. Buchanan, Binghamton, NY (US); Randall S. Cole, Brackney, PA (US); Craig C.F. Fahrenkrug, Vestal, NY (US)

(72) Inventors: Richard A. Buchanan, Binghamton, NY (US); Randall S. Cole, Brackney, PA (US); Craig C.F. Fahrenkrug, Vestal, NY (US)

(73) Assignee: UNIVERSAL INSTRUMENTS CORPORATION, Conklin, NY (US)

(21) Appl. No.: 13/445,044

(22) Filed: Apr. 12, 2012

(51) Int. Cl. B23P 19/00

(52) U.S. Cl. 29/832; 29/743

(57) ABSTRACT

A vacuum nozzle for a pick and place machine that includes a tip having a portion that is configured to interface with a component, wherein at least the portion of the tip is made of wood. The tip may also be made of a material that is at least one of polar and porous. Further, a method of picking up and placing a light emitting diode includes providing a pick and place machine having a vacuum nozzle, wherein the vacuum nozzle includes a tip having a portion that is configured to interface with a component, wherein at least the portion of the tip is made of a material that is at least one of polar and porous. The method includes picking up the light emitting diode and placing the light emitting diode on an electronic assembly.

### BACKGROUND OF THE INVENTION

1. Technical Field

This invention relates generally to vacuum nozzles. More particularly, the present invention relates to a vacuum nozzle for a pick and place machine for picking and placing LED's or other components with an automated process or automated electronic assembly machine.

2. Related Art

Light emitting diodes (LEDs) and other components are typically applied to electronic assemblies using an automated process or automated electronic assembly machine. However, using these processes, it has been found that LEDs or other components will occasionally stick to the vacuum nozzle of the pick and place machine that is applying the LEDs or other components to the PCB. This may be, for example, because nozzle tips are made from non-polar plastic and/or non-porous materials, while LEDs or other components are made with a non-polar silicone based coating. Thus, LEDs or other components intermittently stick to the nozzle, causing the nozzle to sometimes misplace the LEDs or other components on the PCBs or not place the stuck LEDs or other components at all. When LEDs or other components are stuck to the nozzles and the nozzle returns to the feeder to pick up the next LED or other component, a jam is likely to result. As such, it is not cost effective for the PCB to require inspection or repairs due to misplaced or missing LEDs or other components.

Thus, a non-stick pick and place nozzle for LEDs or other components would be well received in the art.

### SUMMARY OF THE INVENTION

According to a first embodiment, a vacuum nozzle for a pick and place machine includes a tip having a portion that is configured to interface with a component, wherein at least the portion of the tip is made of wood.

According to a second embodiment, vacuum nozzle for a pick and place machine comprises: a tip having a portion that is configured to interface with a component, wherein at least the portion of the tip is made of a material that is at least one of polar and porous.

According to a third embodiment, a method of picking up and placing a light emitting diode includes providing a pick and place machine having a vacuum nozzle, wherein the vacuum nozzle includes a tip having a portion that is configured to interface with a component, wherein at least the portion of the tip is made of a material that is at least one of polar and porous.

### BRIEF DESCRIPTION OF THE DRAWINGS

Some embodiments of this invention will be described in detail, with reference to the following figures, wherein like designations denote like members, wherein:

FIG. 1 depicts a perspective view of a vacuum nozzle; and

FIG. 2 depicts a perspective view of a pick and place head having the vacuum nozzle shown in FIG. 1 picking up a component.

FIG. 3 depicts a perspective view of a rotating pick and place assembly having a plurality of the vacuum nozzle shown in FIG. 1.

### DETAILED DESCRIPTION OF THE INVENTION

A detailed description of the hereinafter described embodiments of the disclosed apparatus and method are presented herein by way of exemplification and not limitation with reference to the Figures.

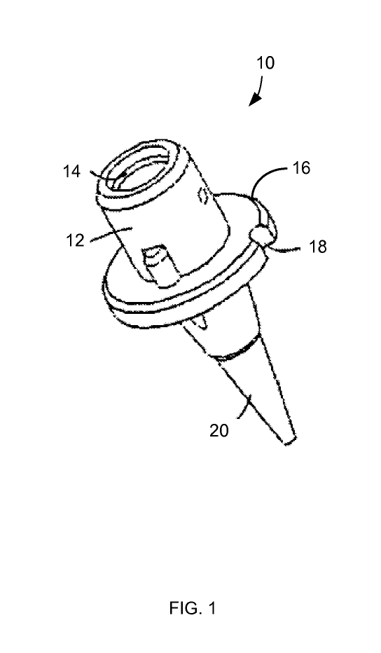

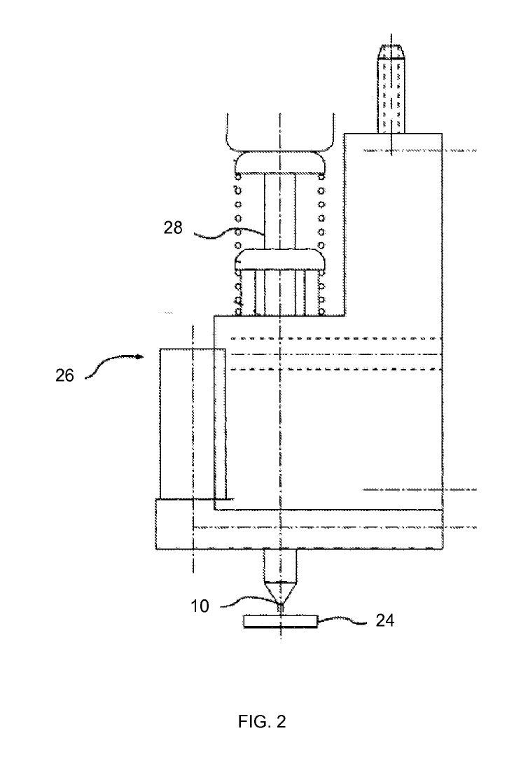

Referring first to FIG. 1, a perspective view of a vacuum nozzle 10 is shown. The vacuum nozzle 10 may include a nozzle body 12, a retaining element 14 at a first end 22, a flange 16, an interface notch 18, and a tip 20. The vacuum nozzle 10 may include various other internal elements known in the art in order to create a vacuum at the tip 20 in order to pick up and place a component 24 (shown in FIG. 2) to a PCB (not shown). It should be understood that the vacuum nozzle 10 is meant to be an exemplary embodiment, and the principles described herein can be applied to any vacuum nozzle for a pick and place machine. The tip 20 of the vacuum nozzle 10 may be made of wood or other polar and/or porous material. This material selection for the tip 20 may prevent sticking between the nozzle tip 20 and the component 24 during a pick and place process.

The vacuum nozzle tip 20 may be made of a material such as wood. In particular, the wood may be Black Walnut wood. Black Walnut may have an advantageous end grain that may contribute to the anti-sticking capabilities of the nozzle tip 20. The dark color of the Black Walnut material may also contribute to the vision recognition of the pick and place machine to ensure accurate placement of components. However, Black Walnut is, of course, not limiting and the material may other types of wood.

Lighter woods, and woods with different characteristics may also be desirable. For example, butternut wood, Persian Walnut, Brazilian Walnut, Cherry, Cedar, Oak, Maple, Hickory, Elm, Chestnut, Blackwood, and the like are also contemplated. This list of woods is not exhaustive and any type of appropriate wood is contemplated. Furthermore, the vacuum nozzle tip 20 may be unstained wood, in one embodiment. In others embodiments, staining may be desirable. Wood may further have a longer life expectancy than typical prior art plastic materials. The wood may also be thermo-treated wood.

Furthermore, materials beyond wood are also contemplated. Materials, both natural, and synthetic and composite, are contemplated. It may be particularly useful if the material has certain material properties. The material may be a polar and/or porous material. Furthermore the material may have a specific gravity between 0.5 and 0.8. Furthermore, a material having a hardness measured by the Janka Ball Test between 850 and 1500 pounds may also be desirable. It may also be desirable for the material of the tip 20 to have a parallel compression strength between 7,000 to 10,000 psi, a bending strength between 9,000 and 18,000 psi, and a bending stiffness between 1,200 and 2,200 kpsi. In some embodiments, the entire tip 20 of the vacuum nozzle 10 may be made of wood or other non sticking material. In other embodiments, a smaller portion of the tip 20 may be made of wood or other non sticking material. At the very least, a portion of the tip 20 that interfaces with component 24 should be made of wood or other non sticking, polar and/or porous material, while the rest may be made from a less expensive plastic material. In other embodiments, the entire vacuum nozzle 10 construction may be made of the same non sticking material such as Black Walnut wood.

In addition, the first end 22 of the nozzle 10 is shown having a tubular shape in the embodiment depicted in FIG. 1. The first end 22 may be adapted to interface with and/or operatively communicate with a vacuum transfer system. For example, the first end 22 of the nozzle 12 may have a retaining element 14, for example a releasable retaining clip, that allows for it to be positioned on the vacuum transfer system and to be removed repaired, or exchanged with additional nozzles.

Referring now to FIG. 2, the vacuum nozzle 10 shown in FIG. 1 may be operably attached to a pick and place head 26. The pick and place head 16 may include a spindle 28 that is configured to move along an axis in order to move the vacuum nozzle along the axis for picking up and placing the component 24. The spindle 28 may be attached to an activating system that causes movement of the spindle 28 along the axis in order to move the vacuum nozzle 10 into a retracted and an extended position. It should be understood that this spindle 28 shown in FIG. 2 is exemplary and not limiting. Any spindle assembly for any type of pick and place machine known in the art is contemplated.

The component 24 may particularly be an LED meant for placement on a PCB. LED's are often particularly sticky in prior art embodiments. However, the vacuum nozzle 10 may be used for picking and placing any type of component for electronic assemblies.

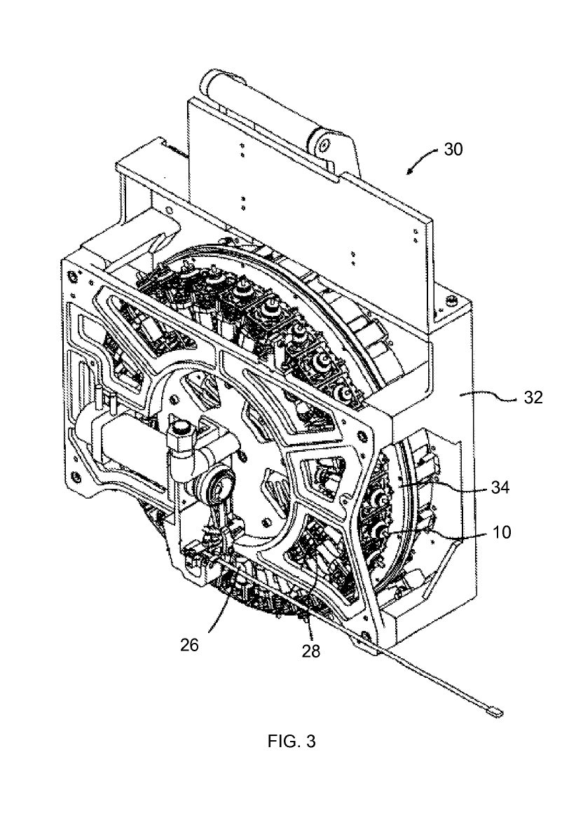

Shown in FIG. 3 is a rotating pick and place assembly 30 having a plurality of the vacuum nozzle 10 shown in FIG. 1. The pick and place assembly 30 may include a housing 32 and a frame 34. The pick and place assembly 30 may include a number of vacuum nozzles 10 and spindles 28 and pick and place heads 26 circumferentially about the rotating assembly 30. While a rotating assembly is shown, any type of pick and place assembly for any type of pick and place machine is contemplated.

Furthermore, a method of picking and placing a component, such as the component 24, is also contemplated. The method may include providing a pick and place machine having a vacuum nozzle, such as the vacuum nozzle 10. The vacuum nozzle may include a tip 20 having a portion that is configured to interface with a component, where at least the portion of the tip is made of a polar and/or porous material such as wood, or Black Walnut. The method may further include picking up the component and placing the component on an electronic assembly.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A vacuum nozzle for a pick and place machine comprising:
a tip having a portion that is configured to interface with a component, wherein at least the portion of the tip is made of wood.

2. The vacuum nozzle for the pick and place machine of claim 1, wherein the component is a light emitting diode.

3. The vacuum nozzle for the pick and place machine of claim 1, wherein the entirety of the tip is made of wood.

4. The vacuum nozzle for the pick and place machine of claim 1, wherein the wood is Black Walnut.

5. The vacuum nozzle for the pick and place machine of claim 1, wherein the wood has a specific gravity between 0.5 and 0.8.

6. The vacuum nozzle for the pick and place machine of claim 1, wherein the wood has a hardness measured by the Janka Ball Test between 850 and 1500 pounds.

7. The vacuum nozzle for the pick and place machine of claim 1, wherein the parallel compression strength of the wood is between 7,000 and 10,000 psi.

8. The vacuum nozzle for the pick and place machine of claim 1, wherein the bending strength of the wood is between 9,000 and 18,000 psi.

9. The vacuum nozzle for the pick and place machine of claim 1, wherein the bending stiffness of the wood is between 1,200 and 2,200 kpsi.

10. The vacuum nozzle for the pick and place machine of claim 1, wherein the portion of the tip that is made of wood is unstained.

11. A vacuum nozzle for a pick and place machine comprising:
a tip having a portion that is configured to interface with a component, wherein at least the portion of the tip is made of a material that is at least one of polar and porous.

12. The vacuum nozzle for the pick and place machine of claim 11, wherein the material is unstained wood.

13. The vacuum nozzle for the pick and place machine of claim 11, wherein the component is a light emitting diode.

14. The vacuum nozzle for the pick and place machine of claim 11:
wherein the material has a specific gravity between 0.5 and 0.8;
wherein the material has a hardness measured by the Janka Ball Test between 850 and 1500 pounds;
wherein the parallel compression strength of the material is between 7,000 and 10,000 psi;
wherein the bending strength of the material is between 9,000 and 18,000 psi; and
wherein the bending stiffness of the material is between 1,200 and 2,200 kpsi.

15. A method of picking up and placing a component comprising:
providing a pick and place machine having a vacuum nozzle, wherein the vacuum nozzle includes a tip having a portion that is configured to interface with a component, wherein at least the portion of the tip is made of a material that is at least one of polar and porous;
picking up the component; and
placing the component on an electronic assembly.

16. The method of picking up and placing the component of claim 15, wherein the material is wood.

17. The method of picking up and placing the component of claim 15:
wherein the material has a specific gravity between 0.5 and 0.8;
wherein the material has a hardness measured by the Janka Ball Test between 850 and 1500 pounds;
wherein the parallel compression strength of the material is between 7,000 and 10,000 psi;
wherein the bending strength of the material is between 9,000 and 18,000 psi; and
wherein the bending stiffness of the material is between 1,200 and 2,200 kpsi.

18. The method of picking up and placing the component of claim 15, wherein the component is a light emitting diode.

19. The method of picking up and placing a component of claim 16, wherein the wood is unstained.

20. The method of picking up and placing a component of claim 16, wherein the wood is Black Walnut.
